(19) United States
(12) Patent Application Publication
(10) Pub. No.: US 2012/0204962 A1
(43) Pub. Date: Aug. 16, 2012

(54) System and Method for Improved Hydrothermal Upgrading of Carbonaceous Material

(75) Inventors: August D. Benz, Hillsborough, CA (US); William Elliott, Mt. Airy, MD (US)

(73) Assignee: Evergreen Energy Inc., Denver, CO (US)

(21) Appl. No.: 13/025,443

(22) Filed: Feb. 11, 2011

(51) Int. Cl. F15D 1/00

(52) U.S. Cl. 137/1; 137/544

(57) ABSTRACT

Methods and apparatus are arranged to increase thermal efficiency, reduce waste water treatment, reduce net usage of fresh water, and improve operational reliability during direct hydrothermal upgrading of carbonaceous materials, including low-rank coals. Drain water collected from the hydrothermal upgrading system is passed through a reboiler system to generate steam which can be returned to the hydrothermal processor system for use therein.

### FIELD

The present disclosure relates to methods and apparatus for providing increased thermal efficiency, reduced waste water treatment requirements, reduced net usage of fresh water, and improved operational reliability during direct hydrothermal upgrading of carbonaceous material, such as low-rank coal.

### BACKGROUND

This section provides background information related to the present disclosure which is not necessarily prior art.

Direct hydrothermal upgrading of carbonaceous material, such as low-rank coals, typically involves batch and/or continuous treatment of these materials in pressurized steam reactors or processor vessels at conditions ranging from 250 to 700 psig and at corresponding saturation temperatures. Such hydrothermal processing produces an upgraded carbonaceous material product which exhibits an increased heating value plus reduced mercury and other contaminant content. Descriptions of direct hydrothermal upgrading processes and treatment conditions have been disclosed, for example, in U.S. Pat. No. 5,071,447 to Koppelman and U.S. Pat. No. 7,198,655 to Hogsett et al. Commonly assigned U.S. Pat. Nos. 5,071,447 and 7,198,655 are incorporated herein by reference.

During and/or after treatment of carbonaceous materials in a hydrothermal reactor/processor and its ancillary equipment (including preheating vessels, lock hoppers, heat exchangers, let-down valves, etc.), a high pressure, high temperature water product is separated from the treated carbonaceous feed material and directed to one or more drains. This “drain water” is recovered at a pressure and temperature slightly below the processor's operating conditions and is comprised of steam condensate produced during direct contact heating of the carbonaceous feed material within the processor, plus water produced and extracted from the carbonaceous feed material through reduction of its contained moisture content. This contained moisture derives from both chemically-bound and adsorbed water within the carbonaceous feed material. As a result of its contact with and its source from the carbonaceous feed material in the reactor/processor, the drain water is comprised of a hot water slurry contaminated with significant quantities of particulate solids, typically coal and mineral particles, plus organic materials and dissolved salts extracted from the raw carbonaceous feed material.

The presence of these solids, organics and salts makes handling and treating of the drain water slurry difficult and complex. From a thermal efficiency standpoint, the sensible heat in this drain water is significant, and may represent a significant portion of the total energy required for treating the carbonaceous feed material. However, it is difficult to recover heat from the drain water slurry due to its tendency to plug piping systems and to foul equipment such as heat recovery exchanger surfaces. As a result, heat recovery from this hot, high pressure drain water has frequently been considered impractical or has been severely limited in commercial applications. In many cases, the drain water has been simply flashed to near-atmospheric pressure without recovery of its thermal energy. Direct flashing of drain water severely degrades it high-level thermal energy, and results in larger required boiler plant size, larger required air and water cooling loads, increased fresh water consumption and increased waste water treatment requirements.

Further, during normal operation of the hydrothermal processor (particularly for batch or batch/continuous processor designs), significant variations routinely occur in the quantity of drain water produced as well as variations in solids, salts and organics contained in the drain water slurry. These variations occur as a result of changes in quality of the carbonaceous feed material or coal, including varying feed material moisture content, friability, and particulate size distribution. Occasional plugging or failure of screens, water drain systems, or other internals and ancillaries within the reactor/processor system, and/or other upsets which are typical for mass-flow treatment processes also cause increased variations in drain water quantity and composition. These normal variations in drain water quality and quantity can cause interruptions to flow which lead to drain water system plugging due to settling and buildup of solids within the collection and handling system. Operating problems associated with such drain water quantity and quality variations in commercial hydrothermal treatment facilities have led to implementation of simple plant designs which do not recover energy from the hot water drain stream.

### SUMMARY

This section provides a general summary of the disclosure, and is not a comprehensive disclosure of its full scope or all of its features.

In one aspect of the invention, a method for handling drain water exiting a hydrothermal processor system for upgrading carbonaceous material includes collecting drain water from the hydrothermal processor system, passing the collected drain water through a reboiler system to generate steam, and returning the generated steam to the hydrothermal processor system.

In another aspect of the present teachings, a drain water system for handling drain water exiting a hydrothermal processor system for upgrading carbonaceous material includes a drain water input coupled for receipt of drain water exiting the hydrothermal processor system, a reboiler system coupled to the drain water input operative to generate steam from the drain water, and a reboiler system output for directing steam back to the hydrothermal processor system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The present teachings will become apparent from a reading of a detailed description, taken in conjunction with the drawings, in which:

FIG. 1 is a schematic apparatus and flow diagram of a known direct hydrothermal treatment of carbonaceous feed materials; including the collection and disposal of drain water from a hydrothermal processor; and

FIGS. 2a and 2b present a schematic apparatus and flow diagram of the same particular configuration of hydrothermal processor system as shown in FIG. 1, with a drain water system arranged in accordance with the principles of the present teachings.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used in this disclosure, a “hydrothermal processor” is a high temperature, high pressure reactor or autoclave which is used to hydrothermally treat carbonaceous feed materials, such as coal of all ranks or grades. As used in this disclosure, the term “flash” or “flashing” refers to partial vaporization or evaporation of a saturated liquid as a result of reduction in pressure due to passing the liquid through a throttling valve or other pressure reducing device. As used in this disclosure, a “reboiler” is a heat exchanger or fired furnace used to generate vapor (e.g., steam) from mixed drain water which flows through the heat exchanger, preferably under forced circulation conditions from a pump or, alternatively, under natural circulation conditions.

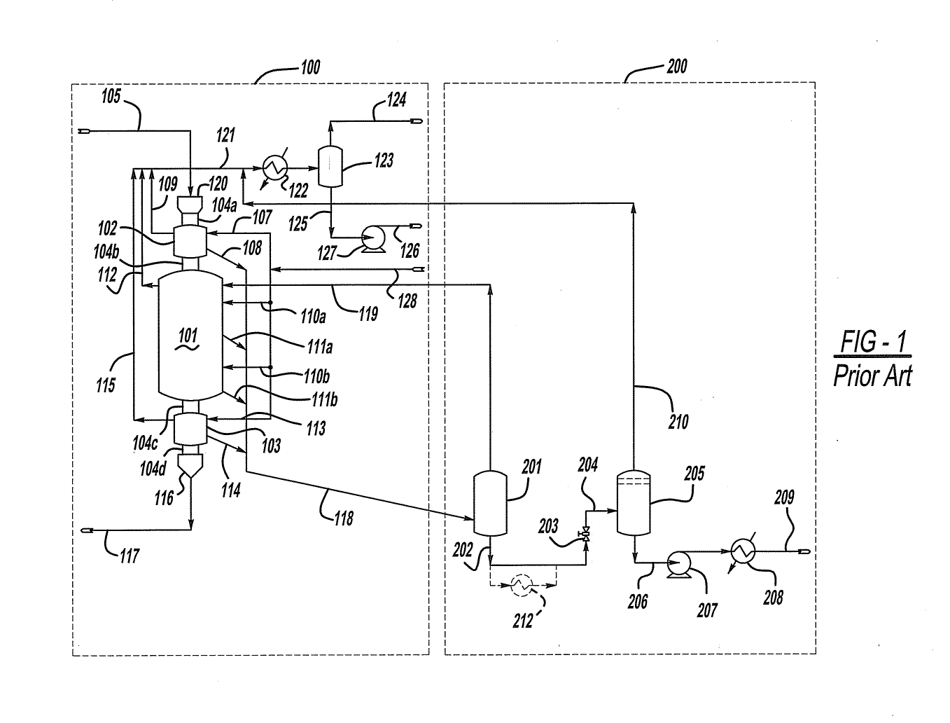

FIG. 1 illustrates a hydrothermal processor system 100 together with a drain water system 200 utilizing prior art direct flash treatment of the drain water. The figure shows a particular configuration of hydrothermal processor system 100 in order to demonstrate the several sources of drain water which may be encountered during hydrothermal treatment and how that drain water may typically be handled. Specific features of the processor and its ancillary equipment are not detailed in the following description, since these specifics are not substantially germane to the processor drain system or the general characteristics of the drain water.

Other processor configurations (e.g., batch reactors, slurry flow reactors, mechanical screw reactors, wiped film reactors, etc.) may be possible and have been described in prior literature and patents, but essentially all hydrothermal processor designs produce one or more drain water streams which have been generally handled as shown in drain water system 200 of FIG. 1.

The hydrothermal processor vessel 101 is fed with screened carbonaceous feed material 105, typically low-rank coal, which is supplied at ambient temperature and pressure to feed bin 120. Feed material enters the processor system by gravity from the feed bin via an inlet lock hopper 102 which has inlet and outlet valves 104a and 104b, respectively. Upon filling of the inlet lock hopper, the inlet valve 104a is closed, and the hopper 102 is pressurized with high pressure steam 107 which partially preheats the feed material. Steam condensate produced by direct contact of the steam with cold feed material drains from the inlet lock hopper 102 via conduit 108. Volatile organic gases and non-condensables produced during the preheating and pressurization of the inlet hopper 102 are relieved via conduit 109 to a vent condenser 122. Once the inlet hopper pressure stabilizes at the pressure desired in processor 101, outlet valve 104b on the inlet hopper 102 is opened, and the preheated and pressurized feed material drops by gravity into processor vessel 101. The inlet hopper outlet valve 104b is then closed, the hopper 102 depressurized to the vent condenser system, and inlet hopper 102 is ready to receive another quantity of feed material. Inlet hopper 102 may be filled and emptied several times per hour in order to maintain the throughput of carbonaceous feed material to processor 101.

In processor 101, additional high pressure steam is introduced through one or more inlets 110a,b on the body of the processor vessel 101 in order to maintain the desired treatment temperature and pressure within the processor, and additional volatiles and non-condensable gases produced during treatment are released to vent condenser 122 via conduit 112. As added feed material is introduced to the processor from lock hopper 102, feed material flows downwardly through processor 101 in a mass flow regime. In processor 101, the contained water in the feed is driven out of the feed material under the high temperature and pressure conditions within the processor vessel. Feed material is held in the processor vessel for an extended time, typically 15 to 150 minutes, in order to complete the hydrothermal upgrading reactions. Drain water comprised of steam condensate plus water removed from the feed material is collected and removed via a plurality of drain connections, such as 111a,b.

As the treated feed material reaches the bottom of the processor vessel by mass flow, it flows through an inlet valve 104c into outlet lock hopper 103. When outlet hopper 103 is filled with treated feed material, valve 104c is closed and hopper 103 is depressurized to vent condenser 122 via line 115. Depressurizing of lock hopper 103 results in most of the contained water in the treated feed material flashing off, resulting in a relatively low free water content in the treated feed material. After depressurizing, outlet valve 104d on outlet hopper 103 is opened, and the treated feed material flows by gravity into product bin 116, which may operate at near atmospheric pressure. The treated feed material is then transferred via line 117 by conventional material handling equipment for cooling, rehydration, dust control and storage as may be required for a particular feed material. Free water or steam condensate that accumulates in outlet lock hopper 103 is drained via line 114. After outlet hopper 103 is empty, outlet valve 104d is closed and the hopper is re-pressurized with steam from line 113 in preparation for receiving another portion of treated feed material from the processor vessel 101. Details of treated product handling of the treated feed material after exiting processor system 100 are not associated with the current teachings and are therefore not illustrated in FIG. 1.

Processor system vent gases at lines 109, 112 and 115 are combined with flash steam in line 210 from the drain water system and sent to vent condenser 122. Condensate and volatile gases pass into vent condenser hotwell vessel 123, which typically operates at sub-atmospheric pressure in order to decrease depressurization time in lock hoppers 102 and 103 during their fill/emptying cycles. Non-condensable gases in line 124 from hotwell 123 flow to a vent gas treatment system (not shown), which typically includes a thermal oxidizer, an acid gas scrubber, and a vacuum blower. Vent gas condensate in line 125 is transferred via pump 127 to a waste water treatment facility (not shown) via line 126.

In the flow scheme illustrated, drain water streams 108, 111a,b and 114 are combined as stream 118 and flow to the drain water collection and handling system 200. In actual practice, a given processor configuration may have many individual drain water lines emanating from each processor system. Details of drain water collection within and around a specific processor are not part of the present teachings. In particular, design of internal collectors, filters, feeders, screens, distributors, and other such solids separators, which allow collection and removal of drain water while retaining essentially all of the feed material within the processor and lock hoppers may be different for each hydrothermal treatment technology, and are not part of the present teachings. In essentially all hydrothermal processing systems, the drain water produced contains significant quantities of solids (such as fine coal and ash particles) plus free and dissolved organic materials including oils and waxes, in addition to dissolved salts, all extracted from the carbonaceous feed material during processing. High pressure steam at 128 is introduced into processor 101 and lock hoppers 102, 103 from a separate boiler (not shown). Essentially all of the steam at 128 is condensed within the processor 101 and lock hoppers 102, 103, and the resulting condensate is produced as contaminated (i.e., containing solids, oils, waxes and salts) drain water from processor system 100.

Note that the processor system illustrated in FIG. 1 may operate in a cyclic, batch/continuous mode. Drain water and vent gas flows from the lock hoppers are cyclic in timing, quantity and composition due to batch operation of the hoppers. Drain water flow from the processor vessel itself is more uniform, since the processor conditions do not change substantially during cyclic operations of the lock hoppers. The variations in drain water quality, plus flow rate variations, as noted in the background discussion above, make operation of the drain water handling system difficult and complex regardless of the type of processor technology used.

Note also that although a single hydrothermal processor is shown in FIG. 1, typical commercial-scale facilities may collect drain water streams from two or more processors and treat the combined drain water in a common treatment system. Similarly, two or more commercial-scale processors may vent gases to a single vent condenser and vent gas treatment system.

FIG. 1 also illustrates a drain water handling system 200 utilizing direct flash treatment of combined drain water, which is common practice in the art. Hydrothermal processing drain water from one or more processors is collected in a drain water holding tank 201. This tank is typically pressure-equalized with the processor(s) via vapor line 119 in order to allow gravity flow of drain water to tank 201 without flashing of the condensate in the drain water collection system. Some drain water streams, such as line 114 from the outlet lock hopper 103, may actually be transferred into tank 201 by a comminution device, such as a pump, rather than by gravity flow.

Combined drain water from holding tank 201, which is a slurry of water and solids, flows via line 202 through de-pressurizing valve 203 into flash tank 205 via line 204. Tank 205 vents flashed steam and volatile gases via line 210 to processor vent condenser 122. The drain water in tank 201 may be at temperatures of 400° to 500° F., depending upon processor conditions. The adiabatic flash of stream 204 from tank 201 into tank 205 can therefore vaporize 25 to 30 weight per cent of the water, and the temperature in tank 205 may vary from about 215° to about 250° F., depending upon tank pressure control. The flashed drain water in line 206 is transferred via pump 207, cooled in heat exchanger 208 to about 140° F., and sent to a waste water treatment facility (not shown) via line 209. The waste water treatment facility may include cooling, clarification, thickening, air floatation, centrifugation, and filtration. Treatment chemical usage in the waste water treatment facility is extensive, due to the nature of the solids and dissolved contaminants in the drain water.

The combined drain water in tank 201 may contain from about 1 to about 5 weight per cent solids, and flashed drain water at 206 may contain up to about 8 weight per cent solids. The solids contents of these streams depend upon the nature and particle size distribution of the carbonaceous feed material being treated in processor 101, the friability of the feed material as it undergoes treatment in the processor, and the effectiveness of the various internal solid/liquid separator devices built into the processor or vessel. Maximum particle size in the combined drain water stream 118 is largely dependent upon the physical screening capability (effective mesh size) of the solid/liquid separator devices and feeders within processor 101. Some agglomeration of feed particles can occur after separation of the drain water within processor 101. This agglomeration may result from high temperature “hot spots” at steam entry points within processor 101, from presence of heavy organics or waxes extracted from the feed material, from buildup of a solid cake in tank 201, or from other causes. In any case, experience has shown that some large solids particles, on the order of one or two inches in diameter, may collect in drain water holding tank 201.

Due to normal upsets in processor operations and the combination of variations in solids content and in particulate sizes in the combined drain water 118 entering the unmixed holding tank 201, it becomes necessary to occasionally reduce or stop flow of drain water through depressurizing valve 203. Flow rate restriction or stoppage can lead to plugging due to settling and packing of free solids in line 202, causing interruption in drain water system operations. Use of proper slurry system design criteria, such as use of cone-bottom vessels, sloped and self-draining slurry pipelines, special let-down valve designs, provision of flushing systems, etc., can reduce plugging problems within the drain water system. Also, intermittent cyclic stroking of valve 203 can further mitigate plugging problems. Nevertheless, dependable and continuous operation of the direct flash treatment scheme 200 as shown in FIG. 1, has proven problematic due to unavoidable flow variations and/or interruptions during normal hydrothermal treatment of feed materials.

Note also that there is little opportunity to recover the high level energy contained in the hot (400° to 500° F.) drain water when using a direct flash system. As shown on FIG. 1, an optional hot drain water cooler 212 has been considered in order to recover some of this energy, but with frequent plugging problems experienced with the mixed drain water stream 202, this option has been deemed impractical.

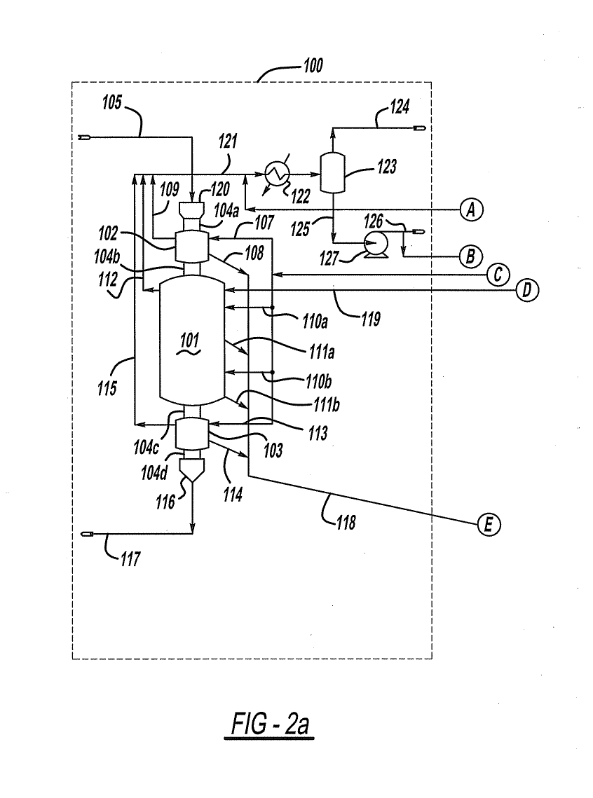

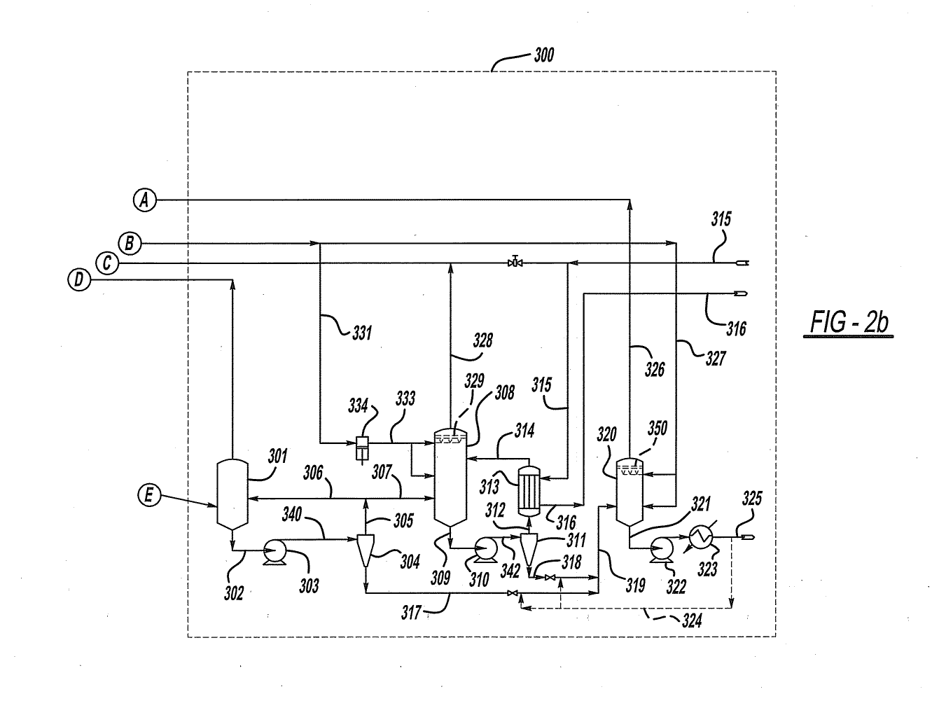

FIGS. 2a and 2b illustrate a hydrothermal processor system 100 together with an improved drain water handling system 300 utilizing the present teachings. The processor system 100 shown in FIG. 2a is essentially identical to that shown in FIG. 1, and is therefore not described further in the embodiment of FIGS. 2a,b.

In improved drain water handling system 300, vent gas condensate (line 126) may be used to provide rehydration and dust control water during final finishing of the treated feed material in line 117.

Hydrothermal processing drain water from one or more processors is collected in drain water holding tank 301. This tank is typically pressure-equalized with the processor(s) 101 via vapor line 119 in order to allow gravity draining of liquid to tank 301 without flashing of the condensate in the drain water collection system. Combined drain water stream in line 302, which is a slurry of water and solids, then flows from tank 301 through input comminution device or pump 303 and delivered to inlet 340 of a centrifugal separator, such as, by example and without limitation, hydrocyclone 304.

Input pump 303 is provided with a so-called “solids-crushing” or “coke-crushing” impeller which reduces large solid particles or agglomerates in the drain water slurry, typically to less than about one-fourth inch in diameter. This comminution of solids as they pass through input pump 303 breaks down larger solid particles which greatly reduces the probability of solids plugging in input pump 303 itself or in the downstream equipment. Such coke-crushing pumps are used in some petroleum refining facilities and other industrial applications, but application of this type pump to hydrothermal upgrading of carbonaceous feed materials is new. Although input pump 303 operates at high suction pressure (250 to 700 psi) the pump can be specified as a relatively low head, low speed, single stage centrifugal pump. These pump characteristics minimize further generation of fine solids and reduce wear and erosion of the pump casing and impeller.

Hydrocyclone 304 typically removes about 90% of the solids in line 302, through application of centrifugal force on the drain water slurry. Note that at hydrocyclone 304 operating conditions of 400° to 500° F. (typically about 475° F.), a sufficient difference exists between the specific gravity of the drain water and the feed material (typically coal) solids contained in the drain water, such that effective centrifugal separation of solids in a simple hydrocyclone is possible. Hydrocyclone overflow 305 will typically contain less than about 0.5 weight per cent solids, and the underflow 317 may vary between about 10 to about 30 weight per cent solids, depending upon how the relative overflow and underflow rates from hydrocyclone 304 are balanced during operations. Normally, hydrocyclone underflow 317 will be set at a fixed flow rate based on the type and feed of carbonaceous feed material to processor 101. The overflow stream in line 305 is split into line 306, which is recirculated to tank 301, and into line 307 which is sent forward to steam separator vessel 308. The flow rate of line 307 to vessel 308 is controlled to maintain liquid level in the drain water tank 301. The flow rate of recirculation line 306 is set to provide sufficient mixing in tank 301 to ensure that solids buildup or settling is avoided in tank 301 by promoting homogeneity within the tank.

Hydrocyclone 304 is shown in FIG. 2b as a single cyclone unit, but 304 may in fact be a multi-pass, multi-stage cyclone array, depending upon the flow rate and characteristics of the slurry solids in line 302. Such hydrocyclones or hydrocyclone arrays have been used in petroleum production facilities, metallurgical plants, and other industrial applications, but application of these hydrocyclones to hydrothermal upgrading of carbonaceous materials is new.

Note that during periods of processor down time, when little or no net drain water 118 is being produced, the continued recirculation of drain water slurry through input pump 303 back to holding tank 301 provides stable, non-plugging operation of the drain water holding tank and its associated input pump 303 and hydrocyclone 304. During conditions when little or no net drain water 118 is being produced, flow of slurry 307 forward to vessel 308 can be readily reduced or even halted, since pipeline 307 is deliberately designed to be short and to be self-draining. Hydrocyclone underflow 317 can also be reduced or halted if needed, since large solid particles have been eliminated from drain water slurry 302 by pump 303 and hydrocyclone 304, and the high operating pressure in hydrocyclone 304 assures restart of underflow slurry flow after brief shutdowns. Water flush systems (not shown) may be provided to clear all slurry lines in the event of longer-term system shutdowns.

Steam separator vessel 308 may comprise a steam generator knockout drum which accumulates the low-solids drain water from hydrocyclone 304 overflow 305 and serves as a reservoir for liquid circulation through reboiler 313. Steam produced in reboiler 313 is sent via line 314 to steam separator vessel 308 where the steam is separated from recirculated liquid in vessel 308, and steam in line 328 is directed back to the processor system 100 via steam inlets 107, 110a, 110b and 113. Separator vessel 308 is maintained at a pressure slightly higher (preferably about 20 psi) than the operating pressure of processor vessel 101 in order to provide direct steam flow to the processor and its auxiliaries, such as lock hoppers 102 and 103.

A slurry of water and solids in line 309 flows from the slurry output of vessel 308 through reboiler pump 310 and is delivered to the inlet 342 of reboiler centrifugal separator, such as a hydrocyclone 311. Since the reboiler system vaporizes a significant portion of total drain water fed to vessel 308, solids will build up in line 309, and solids content may reach about 5 weight per cent or more in this stream. Similar to input pump 303, reboiler pump 310 is specified as a relatively low head, low speed, single stage centrifugal pump in order to reduce wear and erosion of the pump internals. Reboiler pump 310 may also be equipped with a coke-crushing impeller in order to ensure no plugging occurs in the reboiler circulation system, since solids can agglomerate in reboiler 313 and in the reboiler steam separator vessel 308 during extended operation.

Reboiler hydrocyclone 311 is capable of removing up to about 80% of the fine solids in line 309, but water balance considerations around the reboiler system typically require that the reboiler hydrocyclone underflow 318 be flow controlled at a higher rate. Line 318 underflow rate is typically set equal to about 3% to about 10% of net steam production in line 328 (a 3% to 10% “blowdown” rate) in order to limit excess buildup of salts and organics in the recirculating line 309. Line 318 underflow rate will therefore vary uniquely with each type of carbonaceous feed material being treated in processor system 100. Solids content of reboiler hydrocyclone underflow 318 may vary from about 2 weight per cent up to about 15 weight per cent.

Reboiler hydrocyclone overflow line 312 flows directly to an input of reboiler 313, and partially vaporized reboiler outlet flow 314 returns to steam separator vessel 308. Desuperheated boiler steam in line 315 (preferably at about 650 psi or higher) is provided to a shell side of reboiler 313, and clean condensate in line 316 from the reboiler 313 is returned to the boiler feedwater system. Reboiler 313 may be typically specified as a forced circulation, single tube pass unit designed for high tube inlet velocity and reduced film temperature in order to control fouling of the exchange surface caused by the dirty drain water produced from hydrothermal treatment processes. Stainless steel reboiler tubes may be specified in order to resist reboiler tube erosion or corrosion.

The vapor/liquid reboiler outlet at line 314, which typically contains less than about 20 weight per cent vapor, is separated in steam separator vessel 308. Vessel 308 is sized to provide liberal disengaging space so that relatively clean steam in line 328 is produced for return to the processor system 100. Vessel 308 may also contain a demister pad 329 to minimize entrainment of the recirculating reboiler liquid (which will contain solids and dissolved salts and organics) into the steam product in line 328. Normally, some additional makeup water may be required to balance the steam and blowdown flows around the reboiler system. This makeup water, in line 333, is taken from vent gas condensate in processor system 100 and is injected into steam separator vessel 308 via a pump 334. Part or all of stream 333 is used to wash the demister pad 329 in vessel 308 in order to enhance demister performance and to minimize entrainment of fine solids into the produced steam in line 328. Not shown in FIG. 2a,b are provisions for injection of anti-foam agents into the reboiler system in order to improve vapor/liquid separation in vessel 308. At a fixed reboiler blowdown rate (in stream 318) and a fixed makeup water rate (stream 333), the liquid level in steam separator vessel 308 is normally controlled by boiler steam flow rate to reboiler 313.

As noted, produced steam in line 328 flows to processor system 100. Steam is injected into processor vessels on flow control as determined by proper processor operations. If insufficient steam is produced in reboiler 313 to meet the needs of the processor system, additional boiler steam via line 315 is added to maintain steam header pressure at the processor system. Normally, no additional boiler steam at 315 is added. If excess steam is produced in reboiler 313, the pressure in the reboiler and steam separator vessel 308 will increase, which results in decreased production of steam from the reboiler system due to decreased temperature difference in the reboiler.

Hydrocyclone underflow streams 317 and 318 are routed to a processor drain flash tank 320. Tank 320 vents via line 326 to the processor vent condenser 122. Condensate in line 327 from the processor vent condenser 122 is added to tank 320 in an amount sufficient to maintain the flashed slurry in line 321 from tank 320 at about 20 weight per cent solids, in order to ensure reliable transfer and handling of this slurry stream. Tank 320 may also be provided with a demister pad 350 to minimize entrainment of liquids (which contain solids as well as salts and organics) into the flash vapor vent stream 326. The demister pad is washed with a portion of condensate in line 327 in order to enhance demister performance and to further reduce entrainment of solids into the processor vent condenser system. Tank 320 operates above atmospheric pressure in order to control steam flash to the processor vent condenser and typically runs at about 240° F. Hydrocyclone underflow streams 317 and 318 flash in the transfer piping to tank 320. Stream 321, the net liquid from flash tank 320, flows via output pump 322 through cooling heat exchanger 323 and is then transferred to the waste water treatment facility input line 325. In some embodiments, cooled excess liquid 324 from flash tank 320 may be optionally recycled to quench the hot hydrocyclone underflow streams 317 and 318.

The entire drain water system 300 utilizes preferred slurry system design criteria, such as use of cone-bottom vessels, sloped and self-draining slurry pipelines, special let-down valve designs, provision for high pressure flushing, etc., in order to maintain steady operations of slurry systems and to control plugging problems within the drain water system.

As detailed above, hydrocyclones 304 and 311 preferably operate continuously. As is well known, hydrocyclones can readily be operated with continuous overflow but intermittent underflow rates. This intermittent blowdown operation is a useful option during processor system 100 startup or shut-down, or when treating carbonaceous feed material which produces very little fine solids.

Testing of the improved drain water handling system 300 has shown that fouling and scale deposits or buildup within the reboiler system tend to be fairly soft when treating certain low rank coals. These fouling and scale deposits are readily controlled by high velocity flow through the reboiler system, typically at velocities over 9 ft/sec within the reboiler tubes. However, the reboiler may be operated at reduced liquid recirculation rate (but at the same steam generation rate) for extended periods up to several days, depending upon feed material characteristics. After operation for a period at reduced recirculation, the reboiler system is then operated for one or more hours at high circulation rates in order to remove scale and fouling, thereby returning the reboiler to its design capability. This intermittent variation in reboiler recirculation rates reduces reboiler pumping costs substantially.

A further embodiment of the improved drain water handling system may involve contacting the vapor in line 326 from drain flash tank 320 with a condensate makeup 331 to the reboiler steam separator vessel 308, prior to boosting the pressure of stream 331 via pump 334. Direct vapor-liquid contact of these streams serves to pre-heat the makeup condensate 331, thereby adding heat to the reboiler system and reducing the amount of boiler steam 315 required to operate the reboiler. Direct contact of streams 326 and 331 is accomplished by pumping condensate 331 into a tank operating at about 25 to about 60 psia and sparging stream 326 into that tank. Heated condensate is then drawn from the tank through pump 334 and into the steam separator vessel 308. This embodiment may reduce net steam demand to the reboiler by less than 1% and can be economical for large hydrothermal treatment plants.

### COMPARATIVE EXAMPLES

### Example 1

### Prior Art Drain Water System

This example presents hourly averaged flow rates and treatment conditions for a large-scale, single hydrothermal processor which treats screened and sized, sub-bituminous, run-of-mine coal from the Wyoming Powder River Basin. This example is based on full-scale operational data for hydrothermal processing and drain water treatment in general accord with the Prior Art Drain Water Handling System 200 as discussed above and illustrated in FIG. 1. In this example, processor 101 operates at a nominal conditions of 500 psia and 477° F.

Hydrothermal Processor System 100: 157860 lb/hour (79 tons/hour) of net coal feed 105 is delivered to the processor system feed bin 120. Coal feed 105 contains 47,360 lbs/hr (approx. 30.5 weight per cent) total water (both chemically-bound plus adsorbed water). As produced from the processor system, treated coal product 117 totals approximately 117,320 lb/hr (59 tons/hr), containing 12,310 lb/hr (10.5 weight per cent) of contained and free water. 101,930 lb/hr of saturated boiler steam 128 at about 570 psia is delivered to the processor system 100 and injected into processor vessel 101 and into lock hoppers 102 and 103. Vent streams 109, 112 and 115, which flow to vent gas condenser 122, contain a total of about 24,840 lb/hr of water vapor plus 2370 lb/hr of non-condensable gases and about 170 lb/hr of coal solids (dust). Total drain water flow 118 from the processor system is 115,100 lb/hr including 2960 lb/hr (about 2.6 weight per cent) of coal solids. Total vent gas system condensate, stream 126, is 54,610 lb/hr including condensed water from processor system 100 and from the drain water flash tank 210 in system 200. As is apparent from the figures presented here, the average hourly flows of total water and steam entering processor system 100 is 149,290 lb/hr in stream 105 and 128. Correspondingly, total water leaving the processor system in streams 117, 118, and 121 is 149,290 lb/hr.

Prior Art Drain Water Handling System 200: As noted above, total drain water flow, stream 118, entering the drain water handling system is 115,100 lb/hr including 2960 lb/hr (2.6 weight per cent) of coal solids. Stream 118 is collected in drain water holding tank 201, which operates at essentially the same conditions as processor 101, namely about 550 psia and 475° F. The collected drain water stream 202 is depressurized directly via throttling valve 203 into flash tank 205. Tank 205 typically operates at about 25 psia to allow the flash vapor to flow to the vent gas treatment system. The temperature in flash tank 205 is therefore about 240° F. as determined by adiabatic flash conditions of water at that pressure. Flash gas stream 210 is essentially all steam, totaling 29,980 lb/hr, and containing a small quantity (about 20 lb/hr) of coal solids. Flashed drain water 206 totals 85,120 lb/hr, including 2940 lb/hr of coal solids, and flows through pump 207 and cooling heat exchanger 208 to the waste water treatment facility. The stream flow rates defined in this example 1 represent average hourly rates without any interruptions or delays to operations due to system plugging or fouling of equipment in the drain water handling system, even though actual operating experience has shown that such interruptions and delays can occur relatively frequently.

### Example 2

### Drain Water Handling System of the Present Teachings

This example presents hourly averaged flow rates and treatment conditions for a large-scale, single hydrothermal processor which treats screened and sized, sub-bituminous, run-of-mine coal from the Wyoming Powder River Basin. This example is based on full-scale operational data for hydrothermal processing, and with the drain water treatment in general accord with the Improved Drain Water Handling System 300 as discussed above and illustrated in FIG. 2b. The process flows and conditions within the improved drain water handling system described in the example 2 are based on bench-scale and pilot scale testing of actual drain water production from a hydrothermal treatment system.

Hydrothermal Processor system 100: Operating conditions and stream flow rates around processor 101 remain identical to those described in example 1, with the exception that steam is delivered to the processor from the improved drain water handling system 300 rather than directly from the plant boiler.

Improved Drain Water Handling System 300: As defined in example 1, total drain water stream 118 entering the drain water handling system is 115,100 lb/hr including 2960 lb/hr (2.6 weight per cent) of coal solids. Stream 118 is collected in drain water holding tank 301, which operates at essentially the same conditions as processor 101, namely at 550 psia and 475° F. The collected drain water stream 302 flows through input pump 303 and then passes through hydrocyclone 304, where approximately 90% of the solids are removed in underflow stream 317. Pump 303 is provided with a special impeller which reduces solids particles to less than ¼ inch diameter. Hydrocyclone underflow stream 317 is 11,660 lb/hr, containing 2690 lb/hr of coal solids (23 weight per cent solids content). The hydrocyclone overflow stream 305 is split into two streams, 306 which is 11,490 lb/hr plus 307 which is 103,420 lb/hr. Streams 306 and 307 each contain approximately 0.26 weight per cent solids. Stream 306 is recycled back to drain water holding tank 301 in order to ensure good mixing of the collected drain water within the tank and to minimize variations in solids content of drain water during processor system 100 process cycles or operating upsets. Stream 307, totaling 103,420 lb/hr including 270 lb/hr of coal solids, is sent to the steam separator vessel 308. Vessel 308 produces recycle steam for use in the processor system 100, and so operates at conditions slightly higher than processor 101, or about 570 psia and 480° F. Also added to vessel 308 via pump 334 is 3600 lb/hr of processor vent gas system condensate 331. The flow rate of stream 331 to vessel 308 is set primarily to maintain water balance around the improved drain water handling system 300. Stream 331 condensate is essentially pure water, with only traces (about 20 lb/hr) of solids which were collected in the vent gas hotwell 123. A portion of stream 331 is utilized to wash the demister pad within vessel 308 via spray nozzles located below the demister in vessel 308. Condensate stream 331 thereby serves the secondary purpose of improving liquid and solids removal from the steam produced in vessel 308. Stream 309, which includes water and solids accumulated in vessel 308, totals 3,170,000 lb/hr when running at maximum circulation to reboiler 313, or about 1,600,000 lb/hr when running at reduced recirculation rate. Stream 309 typically contains less than 1.0 weight per cent coal solids. Stream 309 flows through reboiler pump 310 and then through the reboiler hydrocyclone 311.

For this example, the hydrocyclone underflow stream 318 is flow controlled to provide a reboiler blowdown rate equivalent to 5% of net steam flow (stream 328) from the reboiler, which is equivalent to 5,100 lb/hr of water in this case. Hydrocyclone underflow stream 318 totals 5390 lb/hr including 290 lb/hr of solids (5.7 weight per cent), which is the total solids entering the reboiler system via streams 307 and 333. The hydrocyclone overflow stream 312, which contains about 1.0 weight per cent solids, flows through the steam-heated reboiler 313.

The reboiler is designed for high velocity/low vaporization conditions in order to minimize fouling and scaling of the reboiler tubes due to the salts and solids content of the recirculating drain water feed to the reboiler. As noted previously, slurry circulation through reboiler 313 is maintained at the design rate for less than 5% of operating time, which is sufficient to control scaling and fouling of the reboiler. Reboiler outlet stream 314, containing steam, water and solids, enters the steam separator vessel 308. Steam generated in the reboiler flows through a demister pad in vessel 308 and returns to the processor system 100 as stream 328 at a rate of 101,930 lb/hr. 107,600 lb/hr of boiler steam 315 at 850 psia supplies heat to reboiler 313, and clean steam condensate 316 is returned to the boiler.

Hydrocyclone underflow streams 317 and 318 combine to line 319, totaling 17,050 lb/hr containing 2980 lb/hr of coal solids, and are depressurized to the processor drain flash tank 320. Tank 320 operates at 25 psia to allow the flash vapor to flow to the processor vent condenser 122. The temperature in flash tank 320 is 240° F. as determined by adiabatic flash conditions of water at that pressure. In addition, 1800 lb/hr of vent gas condensate 327 is added to tank 320 in order to adjust the flashed drain water 321 to a nominal 20 weight per cent solids.

A portion of condensate stream 327 is directed through spray nozzles to wash the internal entrainment separator (demister) within tank 320. Flash gas stream 326 from tank 320 is essentially all steam, totaling 3,890 lb/hr, and containing only a very small quantity of coal solids. Flashed drain water 321 totals 14,960 lb/hr, which contains 2980 lb/hr (20 weight per cent) of coal solids. Stream 321 flows through output pump 322 and cooling heat exchanger 323 to the waste water treatment facility. The net total vent gas system condensate, stream 126, is 23,120 lb/hr including condensed water from the processor system 100 plus from stream 326 in system 300.

### Comparison of Prior Art to Present Teachings:

The advantages of the improved drain water handling system include reduced capital and operating costs for utility services and waste treatment, plus substantial increases in plant reliability and availability. Increased availability for the improved system is expected to exceed two full weeks per year, or almost 4% of annual operating time.

Table 1 below compares average energy and utility service usage rates for the prior art drain water system versus the improved drain water system as described in examples 1 and 2 above. Note these data are for a single processor system producing a nominal 60 ton/hr of upgraded low-rank coal.

Review of this table demonstrates that the improved drain water handling system provides very substantial reductions in waste water treatment requirements, total cooling duty, boiler duty, boiler feedwater preparation, and fresh water usage. The improved system does require a moderate increase in boiler steam production and a substantial increase in total pumping horsepower. The net impact of these changes to the drain water handling system is a major reduction in both capital and operating costs, in addition to improving plant reliability and availability.

TABLE 1

| | Prior Art Drain | Improved Drain | Comparative |
|---|---|---|---|
| Energy/Utility | Water System | Water System | Utility |
| Service | 200 | 300 | Usage |
| Waste water | 139,700 lb/hr, | 38,100 lb/hr, | Improved system |
| produced to | equiv. to 415,000 | equiv. to 113,000 | produces 73% |
| treatment and | gal/day | gal/day | less waste water |
| disposal | | | |
| Total thermal | 65.1 × 10⁶ Btu/hr | 31.6 × 10⁶ Btu/hr | Improved system |
| duty, cooling | (total for | (total for | requires 51% less |
| plus | condenser 122 | condenser 122 | cooling duty |
| condensing | plus cooler 210) | and cooler 323) | |
| High Pressure | 101,900 lb/hr, | 107,600 lb/hr, | Improved system |
| steam use, | saturated at | saturated at 850 | requires 6% more |
| processor plus | 570 psia | psia | boiler steam |
| drain water | | | |
| system | | | |
| Boiler duty, | 104.1 × 10⁶ | 73.3 × 10⁶ Btu/hr | Improved system |
| with credit | Btu/hr heat | heat absorbed | requires 29% less |
| for hot | absorbed | | boiler duty |
| clean | | | |
| condensate | | | |
| return | | | |
| Boiler feed | 208 gpm, no | 4.5 gpm, net of | Improved system |
| water treatment | clean | clean condensate | requires 98% less |
| system capacity | condensate return | returned to boiler | boiler feed water |
| | | | capacity |
| Fresh water | 208 gpm, equiv. | 4.5 gpm, equiv. | Improved system |
| usage | to 300,000 | to 6500 gal/ | uses 98% less |
| | gal/day | day | fresh water |
| Average pump | 10 BHP for | 245 BHP for | Improved system |
| power | pumps 127 and | pumps 127, 303, | pump horsepower |
| requirements | 207 | 310, 322 and 334 | is 235 BHP |
| | | | greater than prior |
| | | | art system |

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for handling drain water exiting from a hydrothermal processor system for upgrading carbonaceous material, the method comprising:
collecting drain water from the hydrothermal processor system;
passing the collected drain water through a reboiler system to generate steam; and
returning the generated steam to the hydrothermal processor system.

2. The method of claim 1 wherein the drain water is collected in a holding tank pressurized at a level substantially equal to that used in the hydrothermal processor system.

3. The method of claim 2 further comprising:
passing collected drain water from the holding tank to a centrifugal separator for separation of solid particulates from the drain water prior to passing the collected drain water through the reboiler system.

4. The method of claim 1 wherein the reboiler system operates at a pressure sufficient to allow the generated steam to be returned directly to the hydrothermal processor system.

5. The method of claim 3 wherein collected drain water is passed using a comminution device equipped with a solids-crushing impeller for reducing size of the solid particulates in the drain water.

6. The method of claim 3 further comprising:
recirculating a portion of drain water exiting the centrifugal separator to the holding tank to maintain contents of the holding tank mixed and substantially homogeneous relative to solid particulate content.

7. The method of claim 6 further comprising:
directing another portion of drain water exiting the centrifugal separator to a steam separator vessel having a steam output coupled to the hydrothermal processor system and a slurry output;
pumping the slurry output to a reboiler centrifugal separator inlet;
directing an overflow outlet of a reboiler centrifugal separator to the reboiler system; and
directing partially vaporized reboiler system output to the steam separator vessel.

8. The method of claim 7 wherein the slurry output of the steam separator is pumped using a pump equipped with a solids-crushing impeller for reducing size of solid particulates in the slurry.

9. The method of claim 7 further comprising:
directing underflow from the centrifugal separator and the reboiler centrifugal separator to a processor drain flash tank; and
passing flashed slurry output of the processor drain flash tank to a waste water treatment facility input.

10. The method of claim 9 wherein the flashed slurry output is passed to the waste water treatment facility input via a cooling heat exchanger.

11. The method of claim 1 wherein the reboiler system utilizes a forced-circulation reboiler unit.

12. The method of claim 1 further comprising:
passing the collected drain water with a comminution device; and
intermittently reducing a circulation rate of the collected drain water through the reboiler system to minimize total pumping energy.

13. The method of claim 1 further comprising:
periodically increasing a circulation rate of collected drain water through the reboiler system to a degree sufficient to substantially remove reboiler tube scaling and fouling and to maintain heat transfer efficiency.

14. A drain water system for handling drain water exiting a hydrothermal processor system for upgrading carbonaceous material, the drain water system comprising:
a drain water input coupled for receipt of drain water exiting the hydrothermal processor system;
a reboiler system coupled to the drain water input operative to generate steam from the drain water; and
a reboiler system output for directing steam back to the hydrothermal processor system.

15. The drain water system of claim 14 wherein the drain water input further comprises a drain water holding tank for collecting the drain water and pressurized at a level substantially equal to that used in the hydrothermal processor system.

16. The drain water system of claim 15 further comprising:
an input pump having an input coupled to an output of the drain water holding tank; and
a centrifugal separator having an input coupled to the input pump output, operative to separate solid particulates from the drain water and to direct separated drain water to the reboiler system.

17. The drain water system of claim 14 wherein the reboiler system operates at a pressure sufficient to allow the generated steam to be returned directly to the hydrothermal processer system.

18. The drain water system of claim 16 wherein the input pump includes a solids-crushing impeller for reducing size of the solid particulates in the drain water.

19. The drain water system of claim 16 wherein an output of the centrifugal separator recirculates a portion of drain water exiting the centrifugal separator to the drain water holding tank, thereby maintaining contents of the drain water holding tank mixed and substantially homogeneous relative to solid particulate content.

20. The drain water system of claim 19 wherein the reboiler system comprises:
a steam separator vessel having a liquids inlet coupled for receipt of another portion of drain water exiting the centrifugal separator and a steam outlet coupled to the hydrothermal processor system;
a reboiler pump having an input coupled to a slurry output of the steam separator vessel;
a reboiler centrifugal separator having an input coupled to an output of the reboiler pump; and
a reboiler having an input coupled to an overflow output of the reboiler and centrifugal separator and an output coupled to an inlet of the steam separator vessel.

21. The drain water system of claim 20 wherein the reboiler pump includes a solids-crushing impeller for reducing size of solid particulates in the slurry output of the steam separator vessel.

22. The drain water system of claim 20 further comprising:
a processor drain flash tank having an input coupled for receipt of reboiler hydrocyclone underflow;
an output pump coupled to a flashed slurry output of the processor drain flash tank and adapted for coupling to an input of a waste water treatment facility.

23. The drain water system of claim 22 further comprising a cooling heat exchanger coupled between an output of the output pump and the input of the waste water treatment facility.

24. The drain water system of claim 14 wherein the reboiler system includes a forced-circulation reboiler.
